(19) United States
(12) Patent Application Publication
(10) Pub. No.: US 2007/0244652 A1
(43) Pub. Date: Oct. 18, 2007

(54) Structure Based Analysis For Identification Of Protein Signatures: PSCORE

(76) Inventors: Carol L. Ecale Zhou, Pleasanton, CA (US); Adam T. Zemla, Brentwood, CA (US); Marisa W. Lam, Pleasanton, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/735,981

(22) Filed: Apr. 16, 2007

Related U.S. Application Data
(60) Provisional application No. 60/791,979, filed on Apr. 14, 2006.

(51) Int. Cl. G06F 19/00

(52) U.S. Cl. 702/20

(57) ABSTRACT

Disclosed herein are computational methods of scoring or characterizing the specificity of residue to a protein of interest based on the frequency the residue occurs in local sequence context in a database. These scored residues can be used to identify protein signatures of interest that are useful, e.g., as targets in developing highly specific ligands for diagnostic or therapeutic uses.

### BACKGROUND OF THE INVENTION

1. Field of Invention

The present invention relates to the field of bioinformatics. More specifically, the invention relates to computational methods for scoring residues based on the frequency of the residue in local sequence context. The invention also relates to methods for identifying protein signatures from the computed scores.

2. Background of the Invention

A motif or signature is a defined region on a target protein that may be used to specifically identify that protein or, indirectly, the organism that produces it. There is an increased need to rapidly develop highly specific detection assays for proteins or organisms which cause biological threat. The identification of signatures specific to proteins or organisms of interest such as pathogens or toxins allows the rapid development of detection assays.

Non-computational methods of identifying protein signatures for high-affinity ligand-based detection include generation of antibodies to whole organisms, whole proteins or peptides. Non-computational methods of identifying protein signatures for reagent development include screening of compounds. In addition to being costly and time-consuming, non-computational methods are based on the principle of discovery and provide no a priori quantitative characterization of the protein residues forming the signature. Consequently, traditional methods based on, e.g., antibody generation or compound library screens provide little information that can be used for down-selecting or targeting the possible pool of reagents.

Current computational methods for identifying protein signatures are largely based on the analysis of conservation through multiple sequence alignment. Residue conservation is an indirect measure of functional or structural importance. Sequence alignments are carried out using utilities such as, e.g., BLAST (available from the National Center for Biotechnology Information website). From such sequence alignments, residues that are conserved within a set of proteins can be identified. Despite the power of techniques which use conservation for generating protein signatures or motifs, they suffer from several shortcomings.

Although signatures based on conservation can often indicate areas that are functionally or structurally important, such signatures are not always specific to a protein of interest. For example, residues found in functional domains such as the basic leucine zipper domain are conserved. However, basic leucine zipper domains are found in large number of proteins and therefore cannot be used to generate a signature which specifically identifies a given protein. Also, methods based on conservation require the a priori knowledge of a group of close homologs or proteins, information which often is unavailable.

Further, methods using multiple sequence alignment generally produce signatures of contiguous residues which may not have proximity in three-dimensional space or may not be found on the surface of a protein, thereby failing to form a signature for reagent or ligand development. Therefore, the evaluation of a measure of specificity for individual residues would be beneficial as it would allow further analyses based on structure.

An alternate method of evaluating specificity of a residue or signature is by the frequency of occurrence in a dataset, for example the non-redundant (NR) set of protein sequences (available at the National Center for Biotechnology Information website). This method is beneficial as it requires no additional information aside from the sequence of the protein of interest.

However, determining the length of sequence with which to search the dataset is difficult. Long sequences are inherently infrequent and signatures are not always comprised of residues contiguous in sequence. Frequencies of individual residues provide little information. The local sequence flanking the residue provides context for an individual residue, however, it is difficult to characterize the specificity of the residue based on a single sequence.

What is needed then is a computational method for identification of protein signatures based on calculation of the specificity of an individual residue to a protein of interest. This method should be further based on multiple measurements of residue frequency in local sequence context.

### SUMMARY OF THE INVENTION

Disclosed herein are computational methods of scoring or characterizing the specificity of a residue to a protein of interest based on the frequency the residue occurs in local sequence context in a database. These scored residues can be used to identify protein signatures of interest that are useful, e.g., as targets in developing highly specific ligands for diagnostic or therapeutic uses.

In one aspect, the present invention provides a method of scoring residue frequency in a local sequence context for a residue in a polypeptide sequence. A first set of subsequences comprising a plurality of contiguous residues and a first residue (i.e., the scored residue) is generated. According to several embodiments of the present invention, the subsequences may consist of 4, 5, 6, or more residues. This first set of subsequences is then used to calculate a set of occurrence frequencies for the first residue, each occurrence frequency based on the occurrence of a subsequence in a dataset of sequence. According to certain embodiments of the present invention, the dataset may comprise a plurality of proteins. A score representative of frequency in a local sequence context for the first residue is generated from the set of occurrence frequencies.

In another aspect, the present invention provides a method of generating a set of occurrence frequencies. A second set of subsequences is generated from a dataset of sequence. Occurrence frequencies are calculated for the second set of subsequences based on their occurrence in the dataset. Records are generated for subsequences in the second set of subsequences, the records comprising the associated occurrence frequency of the subsequence. These records can be searched with the first set of subsequences to identify the occurrence frequencies of the first set of subsequences in a database.

According to the particular embodiment of the present invention, searching said set of records for said subsequence further comprises identifying a record having a subsequence that differs from the search subsequence by one or more residue substitutions, the residue substitution defined by a set of allowed residue substitutions.

In some embodiments, the set of occurrence frequencies will be generated by generating an alignment between a subsequence included within said first set of subsequences and a dataset of sequence, said alignment comprising a correspondence between one or more residues in said subsequence included within said first set of subsequences and one or more residues in the dataset of sequence.

In another aspect, the present invention provides a method for generating a plurality of scores for a plurality of residues in a polypeptide sequence. In some embodiments of the present invention the plurality of scores are combined to generate a score for the polypeptide sequence.

According to certain embodiments of the present invention, the plurality of scores are combined with other scores indicative of the probability that the residue is a surface residue. In other embodiments, the plurality of scores are combined with a score indicative of the conservation of a residue within a group of homologs, the uniqueness of a residue relative to a set of known confounders or a combination thereof.

In some embodiments of the present invention, the plurality scores are displayed on a representation of a three-dimensional structure of a polypeptide sequence.

In another aspect of the present invention, a signature comprising a subsequence of said polypeptide is identified based on a plurality of residues in the subsequence having a score that exceeds a threshold value.

In some embodiments of the present invention, the first score is normalized based on the dataset of sequence. In some embodiments of the present invention, the first score is normalized based on the plurality of scores.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides a conceptual illustration of pScore generation. For each residue of the set of residues ‘ETK’, a set of subsequences four residues in length (4-mers) are generated. This figure illustrates searching the 4-mers against a dataset of sequence using a frequency lookup table. A pScore is generated as a normalized average of the n-mer frequencies.

FIGS. 2a and 2b represent plots of the pScores over linear sequence for residues of a polypeptide. FIG. 2a represents the plot of pScore values over the linear sequence of ricin A. FIG. 2b represents a plot of West Nile Virus envelope glycoprotein. pScores are calcualted and plotted using different lengths of subseuqences. Pink squares denote subsequences of 6 residues in length (6-mers). Yellow squares represent subseuqences of 5 residues in length (5-mers). Blue squares denote subseuqences of 4 residues in length (4-mers).

FIG. 3 shows a mapping of pScores to the three dimensional structure of a protein. The mapping of pScores to the structure of ricin A using B-factor column and temperature factor color setting in Rasmol. Wire frame and space fill views are shown. Values range from low to high (range 0.0 to 1.0, see FIG. 2) as: blue-green-yellow-orange-red. Grey indicates undefined scores at the N- and C terminal regions. Arrow points to a central residue within region R2. Region R2 contains residues with high cuScores and high pScores. The blue residues forming a pocket (center of space fill image in panel a) comprise the active site.

FIG. 4 depicts a mapping of pScores to a three dimensional structural model of West Nile virus envelope glycoprotein. Orange coloring is use to represent residues high (top 25%) cuScores. Blue represents residues with high cuScores and high pScores. The oval marked 1 denotes residues with lowest overall cuScore values. The oval-marked 2 denotes a three dimensional (3D) motif of residues with high pScore and/or high cuScore.

The figures depict various embodiments of the present invention for purposes of illustration only. One skilled in the art will readily recognize from the following discussion that alternative embodiments of the structures and methods illustrated herein may be employed without departing from the principles of the invention described herein.

### Definitions

Residue: An amino acid residue is one amino acid that is joined to another by a peptide bond. Residue is referred to herein encompass the combination of an amino acid and its position in a polypeptide sequence, for example, D31 or A234.

Surface residue: A surface residue is a residue located on a surface of a polypeptide. In contrast, a buried residue is a residue that is not located on the surface of a polypeptide. A surface residue usually includes a hydrophilic side chain. Operationally, a surface residue can be identified computationally from a structural model of a polypeptide as a residue that contacts a sphere of hydration rolled over the surface of the molecular structure. A surface residue also can be identified experimentally through the use of deuterium exchange studies, or accessibility to various labeling reagents such as, e.g., hydrophilic alkylating agents.

Polypeptide: A single linear chain of 2 or more amino acids. A protein is an example of a polypeptide.

Homolog: A gene related to a second gene by descent from a common ancestral DNA sequence. The term, homolog, may apply to the relationship between genes separated by the event of speciation or to the relationship between genes separated by the event of genetic duplication.

Taxonomy: The classification of organisms in an ordered system that indicates natural relationships. As discussed herein, taxonomy is a classification of organisms that indicates evolutionary relationships.

Conservation: Conservation is a high degree of similarity in the primary or secondary structure of molecules between homologs. This similarity is thought to confer functional importance to a conserved region of the molecule. In reference to an individual residue or amino acid, conservation is used to refer to a computed likelihood of substitution or deletion based on comparison with homologous molecules.

Distance Matrix: The method used to present the results of the calculation of an optimal pairwise alignment score. The matrix field (ij) is the score assigned to the optimal alignment between two residues (up to a total of i by j residues) from the input sequences. Each entry is calculated from the top-left neighboring entries by way of a recursive equation.

Substitution Matrix: A matrix that defines scores for amino acid substitutions, reflecting the similarity of physicochemical properties, and observed substitution frequencies. These matrices are the foundation of statistical techniques for finding alignments.

Gapped Alignment: An alignment wherein a space is introduced to compensate for insertions and deletions in one sequence relative to another.

Mismatch: A comparison of two protein molecules where the residues between the two molecules do not share identity at one position. In a single mismatch, all pairs of amino acid residues formed in the comparison between the two molecules are equivalent except for one pair.

Perfect Match: A comparison of two protein molecules where the residues between the two molecules have 100% identity at each position.

### DETAILED DESCRIPTION

The practice of the present invention will employ, unless otherwise indicated, conventional techniques of computational biology, biophysics, structural biology, evolutionary biology, molecular biology and biochemistry, which are within the skill of the art. Such techniques are explained fully in the literature, such as Singleton et al., Dictionary of Microbiology and Molecular Biology 2nd ed., J. Wiley & Sons (1994), Bourne et al, Structural Bioinformatics, J. Wiley & Sons (2002), Fogel et al., Evolutionary Computation in Bioinformatics, Morgan Kaufmann (2002) and Mount, Bioinformatics Sequence and Genome Analysis, Cold Spring Harbor Laboratory (2001).

As noted above, there is demand for a robust method of computationally determining protein signatures which provide the specific identification of a protein. Accordingly, the present invention provides a method for identifying optimal protein sequence and structure motifs, herein referred to as ‘signatures’, for development of detection assays and therapeutics.

These methods are widely applicable for identification of signatures representative of regions suitable for development of diagnostic reagents for proteins expressed by pathogens or associated with disease, virulence, toxicity or for development of therapeutic drugs or antibodies, and may reduce the time and cost of such efforts by identifying up front those regions that are optimal for reagent targeting in terms of specificity for the proteins of interest and that pose the least risk in terms of cross-reactivity by other proteins.

The present invention provides methods of scoring residues based on residue frequency in local sequence context. The present invention further provides a method of generating occurrence frequencies based on a dataset of sequence. Accordingly, the methods of the present invention provide for the identification of residues in proteins that are unique to a protein of interest. The score or scores generated for the residues are stored on a client device or a server. In some embodiments, the scores are outputted to a display on a client device.

In addition, the scored residues can be projected onto a three dimensional structure of the protein of interest for signature determination, herein referred to as the reference polypeptide. Such methods provide a way to identify regions on proteins that are surface exposed and amenable to binding by small molecule ligands or antibodies that will specifically recognize the reference polypeptide.

The scored residues may also be filtered by a threshold value to determine regions or subsequences of high scoring residues. Accordingly, this method provides the identification of signatures comprised of subsequences contiguous in two-dimensional sequence.

The scored residues may be combined to provide a score representative of the overall specificity of a protein based on local sequence context. Accordingly, the present invention provides a method for the identification of proteins as potential candidates from which to develop protein signatures.

The identification of a signature according to the methods of the invention enables development of reagents such as small chemical ligands or antibodies and assays using such reagents for highly specific detection of the target.

While the present method finds use in detecting any pathogen or target, preferred pathogens include but are not limited to, avian influenza, Ebola virus, dengue virus and the like. Others include SARS (coranavirus). Additionally, the same methods may be used for the detection of bacterial pathogens such as Bacillus anthracis, Escherichia coli, and Yersinia pestis. The method finds further use in the detection of plant based toxins such as abrin and ricin.

In the development of therapeutics, the present invention finds use in the identification of signatures specific to a protein or a region of a protein. Identified signatures for regions such as those conferring virulence, drug resistance or metastatic properties can be used to develop reagents to selectively block functionality of the regions.

pScore

The present invention provides method for calculating for one or more residues a score, herein referred to as a pScore, representative of the residue frequency in local sequence context.

A scoring function maps an abstract concept to a numeric value. pScores are generated to assign a quantitative value to the specificity of a residue to a protein sequence relative to a dataset of sequence.

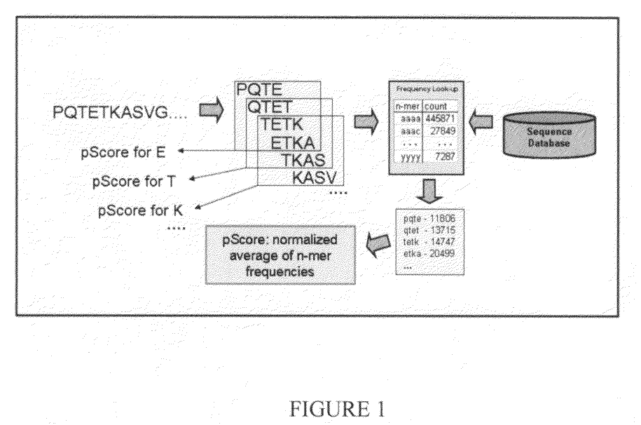

In the method of the present invention, a set of subsequences are generated from a polypeptide sequence which contain a residue being scored. This set of subsequences can contain subsequences of different lengths. However, the majority of discussion of the present invention is directed to embodiments in which the subsequences in the set are of the same fixed length. These subsequences are herein referred to as n-mers, where n represents the number of residues in the subsequence. Depending on the application of the present experiment, the n-mers preferably are 4, 5 or 6 residues in length (FIG. 1). The full set of all amino acid n-mers generated to include a given residue will have n sequences.

A sliding window approach provides a way of generating all n-mers which include a given residue. In a sliding window approach, an n-mer of a fixed size is advanced one position in sequence to generate a set of n-mers, each n-mer differing from another by one residue (FIG. 1).

For each n-mer in the set, occurrence frequencies are calculated based on the occurrence of the n-mer in a dataset of sequence. The occurrence frequency can be represented as number of occurrences of the n-mer in the dataset. The occurrence frequency can also be represented relative to the number of n-mers in the dataset or a subset of the dataset, for example, all sequences in the NR sequence database which are Flavivirus sequences. Various other methods of computing and representing the occurrence frequency value will be apparent to those skilled in the art of the present invention.

According to the embodiment of the present invention, the set of occurrence frequencies can be combined to generate a pScore using a variety of methods. Combining, as referred to herein, is used to designate any mathematical operation or combination of mathematical operations including, but not limited to adding, subtracting, multiplying, or dividing. The occurrence frequencies for the set of n-mers may be averaged, that is summed and divided by n. Alternatively, a high or low occurrence frequency can be selected from the set of occurrence frequencies as the pScore.

pScores can be normalized using any combination of mathematical formulae and data derived from the polypeptide or the dataset of sequence (FIG. 1). For example, when comparing across n sizes, pScores can also be normalized with a log function to remove skewing caused by distribution bias. pScores can be normalized relative to the distribution of the subsequences in a dataset or a pre-defined subset of the dataset.

An additional method of normalizing the pScore for a residue in a polypeptide sequence is normalizing relative to the set of other pScores calculated for the same polypeptide sequence. For example, maximum and minimum pScores for a given protein are determined and a normalized pScore is computed as:

pScoreₙₒᵣₘ=1−((pScore_{original}−pScoreₘᵢₙ)/(pScoreₘₐₓ−pScoreₘᵢₙ))

### This method can be extended to include pScores generated for each residue in a set of proteins.

The pScores may be combined to provide a score representative of the overall specificity of local sequence in a protein. In one application of the present invention, pScores are calculated and combined by producing an average pScore value for a group of proteins. The calculated scores can then be used to rank proteins in the group relative to each other in order to select proteins as potential candidates from which to develop protein signatures.

In some embodiments of the present invention, a summary file is generated for each pScore from a protein or a set of proteins. The summary files describe the statistical spread of the pScore data. Statistics such as maximum pScore, average pScore, minimum and normalized pScore are provided in the summary file.

‘Those skilled in the art will readily recognize the utility and possibilities inherent in combining pScores with scores representative of the structural conservation of residues or structural uniqueness relative to a set of confounding proteins. By combining these scores, a user can add extra information regarding the relative functional and structural importance of the residue. In some embodiments, this residue frequency is based on the structural conservation and uniqueness of the residue as described in an application titled Structure Based Analysis for Identification of Protein Signatures: cuScore, filed on Apr. 16, 2007, incorporated herein by reference.

The pScores may also be combined with scores indicative of the probability a residue resides on the surface of the ternary structure of a protein. This added information aids in finding residues that are surface exposed and amenable to binding by small molecule ligands or antibodies. It is well known to those of ordinary skill in the art how to assign a probability associated with the likelihood that a residue is a surface residue. Examples of ways to obtain such probabilities include, e.g., computational algorithms such as those implemented in PredictProtein (Rost and Liu, 2003). Another method of predicting surface accessible residues incorporates the use or creation of a three dimensional model of the protein structure.

### Generation of Occurrence Frequencies

This present invention also provides methods for generating an occurrence frequency for a subsequence based on the occurrence of the subsequence in a dataset.

In one embodiment, the occurrence frequencies are generated by sequence alignment. The set of n-mers is aligned against the dataset of sequence using any implementation of a sequence alignment algorithm (e.g. BLAST, BLAT, FASTA, HMMer). The sequence alignment algorithm can incorporate the use of gapped alignment or mismatches. Accordingly, the matches derived from the alignment may include perfect matches, mismatches and gapped alignments. These matches are then used to generate an occurrence frequency. In the generation of an occurrence frequency, matches can be weighted based on the “goodness” of the match with perfect matches having a higher weight than mismatches or gapped alignments.

In one embodiment of the present invention, an occurrence frequency is generated by searching a set of records (FIG. 1). In this method, n-mer occurrence frequencies are calculated for the possible 20ⁿ amino acid n-mers sequences in a dataset and a set of records is created containing the n-mers and their frequencies in the dataset. These records can be stored in a searchable index of records. According to the embodiment, the records are updated to reflect changes in the dataset. These updates may happen at any time interval such as: daily, weekly or monthly or asynchornously.

According to the application of the present invention, records may be searched only for perfect match sequences. Alternatively, the searches may allow defined mismatches or residue substitutions. Mismatches can be weighted relative to perfect matches to generate the occurrence frequency for the query subsequence.

Various configurations and architectures of storing and searching the records will be readily apparent to those with ordinary skill in the art. The records can be stored in a searchable index to facilitate lookup in any manner of ways. Additionally, the records may be searched using parallel processing to optimize the lookup process.

In a specific example, the frequencies of 20ⁿ amino acid n-mer sequences are calculated for n ranging from 1 to 6. The n-mer combinations are converted into a sorted bit counting array using binary shift operations. A flat-file fixed width index is used to speed up look-up time of a given n-mer frequency. Searches are conducted using BLOSUM matrices to pre-define allowable residue substitutions.

### Signature Identification

According to certain embodiments of the present invention, the calculation of scores provides information used in the identification of a subset of residues which form a protein signature.

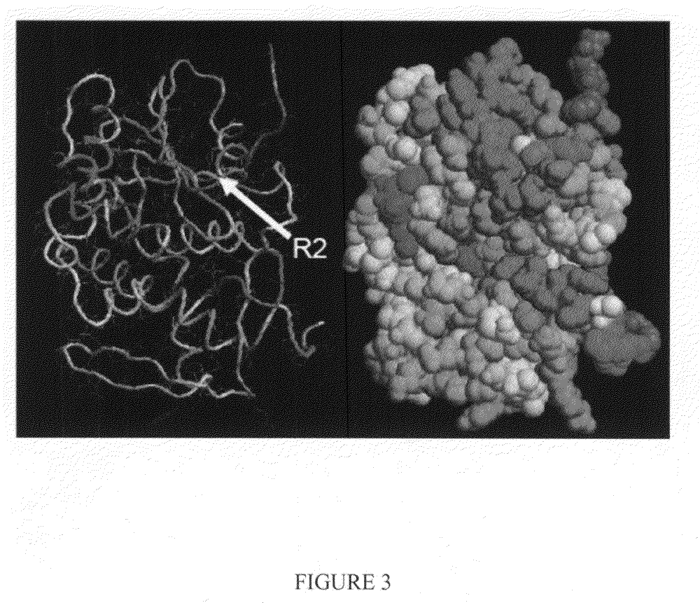

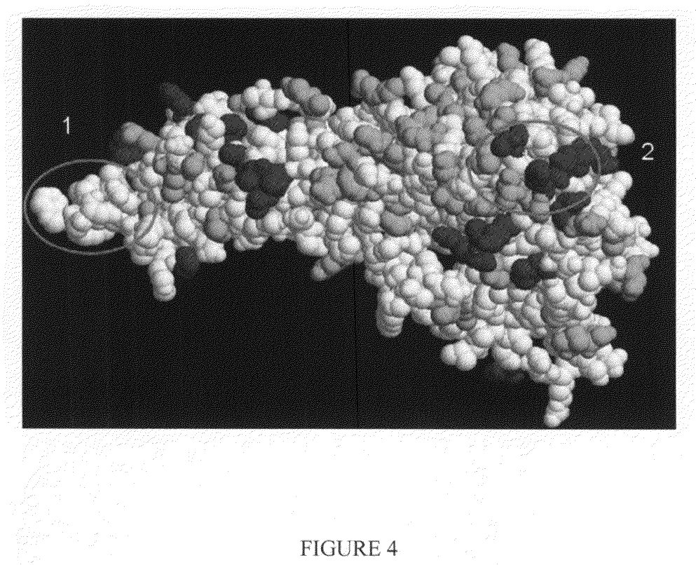

In some embodiments of the present invention, conservation uniqueness scores are displayed onto a three dimensional representation of a polypeptide to identify a set of high scoring residues on the surface of the protein which are proximate in three dimensional space (FIG. 3, FIG. 4). This display is used to identify a set of residues which define a protein signature. This set can contain any number of residues but in most embodiments will be three or more residues, such as, e.g., three, four, five, six, seven, eight, nine, ten, or more residues. In alternate embodiments, high scoring values with residues proximate in three dimensional space can be identified computationally.

In one embodiment, only scores above or below a certain threshold value are displayed on the three dimensional representation. In another embodiment, residues are colored according to score. In another embodiment, these scores are displayed along with other scores representative of other data such as structural conservation or the uniqueness of a residue relative to a set of confounders.

According to the application of the present invention, various programs for rendering the three dimensional display of a protein from a set of atom coordinates are employed in this method. RasMol is a common program for molecular graphics visualization. Other programs used to visualize three dimensional protein structures include Chime and Protein Explorer.

In another embodiment, the pScores are used to generate a signature comprised of a subsequence including residues with pScores above a threshold value. A threshold value may be specified to filter for stretches of contiguous residues containing residues that are above the threshold value. For example, if scores are normalized to a value between one and zero, the threshold value may be set to 0.75. Alternatively, the threshold value may be based on a percentile cutoff based on a distribution of pScores for residues in one or more proteins.

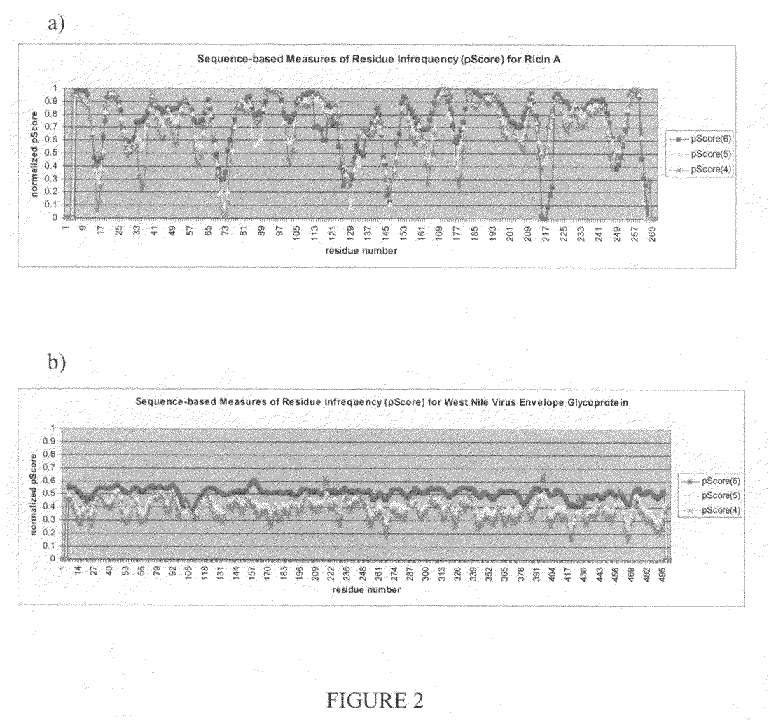

The pScores can also be projected onto a linear representation of the two-dimensional amino acid sequence in order to visualize signatures of residues contiguous in linear sequence (FIG. 2).

In one embodiment, the scores are displayed as a line graph where the amino acid sequence is plotted along the x-axis and the numeric values of the scores are displayed on the y-axis (FIG. 2). The scores can also be displayed on the y-axis along with other scores including, but not limited to, scores representative of residue frequency in local sequence context. In some embodiments, the scores can be represented by coloring the residues in the correspondence or by other visualization techniques.

### Residue Substitutions

In addition to evaluating the frequency of perfect matches, various methods that incorporate the use of mismatches or gapped alignments can be used to score the relative frequency of a sequence. The substitutions allowed in the mismatch can be defined by substitutions matrices and allowable substitutions based on protein groupings or alphabets. Those of ordinary skill in the art having the benefit of the instant disclosure can envision a variety of other comparable methods of defining allowed residue substitutions.

Substitution matrices represent the rate at which each possible residue in a sequence changes to each other residue over time. Substitution matrices are 20 by 20 matrices containing preferred substitutions propensity for all possible pairs of amino acids. The preferred substitution propensities may be calculated based on a set of homologous sequences or many sets of homologous sequences. Two substitution matrices for amino acids commonly used in the art are PAM (Point Accepted Mutation) and BLOSUM (BLOck SUbstitution Matrix). Substitution matrices may also be used to create a grouping such as above by identifying the grouping of amino acids which minimizes the off diagonal elements in the substitution matrix. (Fygenson et al., 2004).

In another embodiment of the present invention, pre-defined groupings based on amino acid characteristics can be used to specify allowable substitutions. One method of grouping the 20 known amino acids is by chemistry and size: aliphatic (AGILPV), aromatic (FWY), acidic (DE), basic (RKH), small hydroxylic (ST), sulfur-containing (CM) and amidic (NQ).

Other grouping schemes are based on functional properties such as: acidic (DE); basic (RKH); hydrophobic non polar (AILMFPWV); and polar uncharged (NCQGSTY). An example of a grouping scheme based on the charge of amino acid is: acidic (DE); basic (RKH) and neutral (AILMFPWV NCQGSTY). A grouping scheme based on structural properties is: ambivalent (ACGPSTWY); external (RNDQEHK); internal (ILMFV) (Karlin and Ghandour, 1985).

Other grouping schemes based on physical properties such as codon degeneracy or kinetic properties can also be employed to specify allowable substitutions.

### Dataset Selection

According to the application of the present invention, various datasets of sequence may be selected. The dataset can include a single sequence, a known database of sequence or a selected dataset of sequence.

Databases of protein sequence include the Non Redundant set of protein sequence (NR) (available at the website of the National Institute for Bioinformatics Information) and SwissProt (available at the website of the European Bioinformatics Institute). Subsets of these databases may be selected by any number of criteria such as organism.

The selection of a dataset of homologous sequences is beneficial as it allows for frequency calculation based on closely related sequences. This method increases the stringency of the pScores by using only sequences known to have a high degree of similarity. A dataset can be selected from homologs using various methods of comparison to the protein of interest such as sequence similarity, structural similarity, or taxonomy. Those skilled in the art can picture a variety of combinations of the following methods.

One method of determining homologs is through the use of structural similarity alignments using programs such as LGA. Using structural similarity comparison, a known protein structure may be aligned with a database of other known structures such as PDB (Protein Data Bank). Cutoff values for structural homologs may be specified using the root mean squared deviation (RMSD) or distance between residues in Angstroms.

Sequence similarity comparisons form another method of selecting a set of homologous sequences. Various methods of sequence-sequence comparison (BLAST, HMMer, etc) can be used to generate a metric of sequence similarity and identify close sequence homologs or target polypeptides. Conversely, threshold values can be set to identify near neighbor polypeptides which have lower sequence similarity and are likely to cause interference.

A phylogenic taxonomy provides a known or accepted classification of groups of organisms based on evolutionary relatedness. Taxonomy can be used to determine sets of homologs. In the absence of a known phylogeny, a calculated molecular phylogeny may be created using sequence similarity comparisons. In these analyses, a distance matrix between similar sequences is created to generate a measure of evolutionary distance. These distances are then clustered to create phylogenetic trees representative of sequence divergence due to evolution. Common algorithms for clustering include neighbor joining and UPGMA (Unweighted Pair Group Method with Arithmetic mean, Prager and Wilson, 1978). Phylogenetic tree data may be used to select homologs in the same manner as taxonomy is used.

### Protein Structure Modeling

The protein structure used to display the scored residues may be determined in a variety of methods. Protein structures are sets of solved atomic coordinates representative of a three dimensional structure of a protein. These coordinates are solved for atoms including, but not limited to, alpha carbons, beta carbons, or side chain atoms. These sets of solved atom coordinates can also represent some substructure of a protein or polypeptide. Atomic coordinates can be solved experimentally using a variety of techniques such as x-ray crystallography, electron crystallography and nuclear magnetic resonance.

Despite the accuracy of experimental techniques, they are costly and time-consuming. Advances in protein structure prediction or modeling provide methods of computationally solving the set of atom coordinates for a given protein. These methods are generally based on three different techniques (sequence comparison, threading and ab initio modeling). Protein structure prediction or modeling is usually practiced as a combination of these techniques.

A favored method in the art of protein structure prediction is to find a close homolog for whom the structure is known. CASP (Critical Assessment of Techniques for Protein Structure Prediction) (Moult et al., 2003) experiments have shown that protein structure prediction methods based on homology search techniques are still the most reliable prediction methods. Sequence comparison and threading techniques are based on homology search.

Sequence comparison approaches to protein structure prediction are popular due to availability of protein sequence information. These techniques use conventional sequence search and alignment techniques such as BLAST or FASTA to assign protein fold to the query sequence based on sequence similarity.

Approaches which use protein profiles are similar to sequence-sequence comparisons. A protein profile is an n-by-20 substitution matrix where n is the number of residues for a given protein. The substitution matrix is calculated via a multiple sequence alignment of close homologs of the protein. These profiles may be searched directly against sequence or compared with each other using search and alignment techniques such as PSI-BLAST and HMMer.

It is known that sequence similarity is not necessary for structural similarity. Proteins sharing similar structure can have negligible sequence similarity. Convergent evolution can drive completely unrelated proteins to adopt the same fold. Accordingly, ‘threading’ methods of protein structure prediction were developed which use sequence to structure alignments. In threading methods, the structural environment around a residue could be translated into substitution preferences by summing the contact preferences of surrounding amino acids. Knowing the structure of a template, the contact preferences for the 20 amino acids in each position can be calculated and expressed in the form of a n-by-20 matrix. This profile has the same format as the position specific scoring profile used by sequence alignment methods, such as PSI-BLAST, and can be used to evaluate the fitness of a sequence to a structure.

Ab initio methods are aimed at finding the native structure of the protein by simulating the biological process of protein folding. These methods perform iterative conformational changes and estimate the corresponding changes in energy. Ab initio methods are complicated by the inaccurate energy functions and the vast number of possible conformations a protein chain can adopt. The most successful approaches of ab initio modeling include lattice-based simulations of simplified protein models and methods building structures from fragments of proteins. Ab initio methods demand substantial computational resources and are also quite difficult to use and expert knowledge is needed to translate the results into biologically meaningful results. Despite known limitations, Ab initio methods are increasingly applied in large-scale annotation projects, including fold assignments for small genomes. Recent examples of such applications include: Bonneau et al. 2001, Kuhlman et al. 2003 and Dantas et al. 2003.

In practice, protein structure prediction typically involves a combination of the listed techniques, both experimental and computational. Hybrid approaches to protein structure prediction involve using different techniques for solving the atom coordinates at different stages or to solve for different parts of the protein structure. An example of this would be the use of AS2TS (amino acid to tertiary structure, a homology modeling technique) to facilitate the molecular replacement (MR) phasing technique in experimental X-ray crystallographic determination of the protein structure of Mycobacterium tuberculosis (MTB) Rm1C epimerase (Rv3465) from the strain H37rv. The AS2TS system was used to generate two homology models of this protein that were then successfully employed as MR targets.

Meta-predictors or consensus approaches attempt to benefit from the diversity of models by combining multiple techniques. In these methods, predictive models are collected and analyzed from a variety of different computational and experimental techniques. A common approach for combining models by consensus is to select the most abundant fold represented in the set of high scoring models. Other approaches to consensus modeling involve structural clustering such as HCPM-Hierarchical Clustering of Protein Models (Gront and Kolinski, 2005).

In one embodiment of the present invention the protein structures are predicted using the AS2TS program. The AS2TS system uses homology modeling to translate sequence-structure alignment data into atom coordinates. For a given sequence of amino acids, the AS2TS (amino acid sequence to tertiary structure) system calculates (e.g. using PSI-BLAST analysis of PDB) a list of the closest proteins from the PDB, and then a set of draft 3D models is automatically created.

### EXAMPLE 1

### Identification of Signatures in A Chain of Ricin

An entry (ID=RICI_RICCO, P02879) from the SHIGARICIN family of the PRINTS database of virulence factors as a reference sequence for our analyses of the A chain of ricin. Of the 21 PDB structures of the ricin A chain, the three non-redundant, non-mutant structures that had been solved with highest resolution (PDB entries 1br6, 1br5 and 1rz0) to include in the target set for our structure-based analyses were selected. These structures had sequence similarity between 93 and 100% (and corresponding structure-similarity LGA_S score between 95 and 100%) to the ricin A reference. Using the AS2TS (Zemla et al., 2005, http://as2ts.11n1.gov/) automated homology-based protein structure modeling system, PDB entry 1br6 was selected as the 3D model structure of the ricin A reference sequence, because it had the greatest sequence similarity (100% sequence identity) and structure completeness from among available PDB structures (100% of structure solved with resolution of 2.3 Å).

The pScore was devised as a measure of residue infrequency in local sequence context. We applied a ‘sliding window’ approach to generate all subsequences of length n (n=4, 5 or 6) for the reference ricin A sequence. Initial tests using larger window sizes (up to 10) indicated that window sizes >6 yielded matches primarily to ricins and close homologs and, therefore, did not provide useful information about potential cross-reactivity posed by distantly related or unrelated sequences. We then determined how often each subsequence occurred in the NR database. This was called a subsequence's ‘popularity’. For each residue in the reference sequence, a score was computed as the sum of the popularity values for each of the n windows that the residue was a member of, divided by n (=average popularity for a set of n windows containing the residue), thus each window was weighted equally. We saw no justification for assigning greater weight to any window within a given pScore calculation; we felt this was justified because residue side-chains tend to alternate direction in 3D space, and therefore a set of residues participating in a ligand binding reaction may tend to occupy alternating positions along the chain. Using pScore analysis, we were looking for regions that occurred with relative infrequency.

For our convenience, we normalized the scores so that they would range from 0 to 1 and could be meaningfully plotted alongside cuScores. Normalization was done as follows. The minimum and maximum scores were determined (from among scores of all subsequences) and pScore was computed as 1-(score-minimum)/(maximum-minimum). For example, using n=4 the 4 subsequences generated for residue 65 had average frequency, 6281+2664+2256+6594/4=4448.75. With minimum and maximum frequencies set to 1824 and 29011.75 respectively, the normalized pscore for residue 65 was calculated as 1−((4448.75−1824)/(29011.75−1824))=0.90.

pScores for residues at the N- and C-termini for which there was incomplete data (fewer than n windows containing a given residue) were left undefined. pScores were plotted against ricin A residue number (FIG. 2a).

Visualization of surface-exposed regions containing residues with high pScores was facilitated using RasMol (Sayle and Milner-White, 1995) to color code low- to high-scoring residues (FIG. 3). pScores were loaded into the b-factor column of the reference ricin A 3D coordinates file and displayed using RasMol's color-temperature setting. We used cuScore and pScore (see patent application titled Structure Based Analysis for Identification of Protein Signature: cuScore by Carol Zhou and Adam Zemla filed Apr. 16, 2007 values and these 3D color plots, along with Naccess (Hubbard and Thornton, 1993) solvent accessibility calculations (data not shown), to visually identify surface loops or binding pockets suitable as antibody or small molecule ligand targets. By visual inspection of the residues comprising region R2, we determined that this subsequence was composed mostly of residues with high cuScores and pScores (FIG. 3).

### EXAMPLE 2

### Identification of Signatures in the West Nile Virus Envelope Glycoprotein

The method of the present invention was also used to identify motifs on the envelope glycoprotein of West Nile virus. Data from the literature was then used to evaluate the success of these predictions.

The envelope glycoprotein of West Nile virus (refseq strain) was selected as the reference sequence and was blasted against the non-redundant (NR) protein database to capture related Flavivirus sequences. The subject and query sequences were then modeled using AS2TS.

pScores were generated for all subsequences of length n (n=4, 5 or 6) for the envelope glycoprotein reference sequence and normalized to a range between 1 and 0, as discussed above. For example, using n=4 the 4 subsequences generated for residue 399 had frequencies and average frequency of 1012+1269+4990+23990/4=7815.25. With minimum and maximum frequencies set to 882 and 180192 respectively, the normalized pScore for residue 399 was calculated as 1−((7815.25−882)/(180192−882))=0.96.

Residues with the highest cuScores and pScores were mapped onto the WNV model (FIG. 4). pScores were plotted against WNV envelope protein residue number (FIG. 2b). Residues with high cuScore and/or pScore values were color coded to facilitate identification of conserved/unique motifs. A region in domain III (FIG. 4, oval #2) composed of high-scoring residues was determined to coincide with a well known neutralizing epitope.

The Immune Epitope Database (Peters et al. 2005) was searched for references to papers describing mAbs that had been epitope mapped to the residue level. Results of binding studies for all such existing mAbs, raised against WNV, SLE, and Dengue2 Flavivirus envelope glycoproteins and described in six publications (Oliphant et al. 2005, 2006; Crill et al. 2004, Roehrig et al. 1998, Megret et al. 1992; Sanchez et al. 2005), were summarized.

Using the present invention, a feature was predicted in the WNV envelope glycoprotein defined by a cluster of residues including S306, K307, T330, and T332 (FIG. 4, oval #2) that display properties of conservation/uniqueness, and that a cluster of residues in the fusion loop (FIG. 4, oval#1) with the lowest scores in our analyses would be unsatisfactory for detection reagent development due to the potential for cross reactivity with other Flaviviruses. WNV mAbs that recognize a neutralizing epitope (Domain IIIa) are highly specific for WNV, failing to bind to many other Flaviviruses, whereas mAbs recognizing the WNV (Oliphant) or SLE (Crill) fusion loop region are cross reactive across the genus, and 3 of 4 mAbs recognizing the fusion loop of Dengue2 are cross reactive to varying degrees within the genus.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims. All references disclosed in this specification, including references to books, scientific articles, patent applications, patents, and other publications are hereby incorporated by reference in their entirety for all purposes.

### REFERENCES

Zhou, C E, A Zemla, D Roe, M Young, M Lam, J S Schoeniger, and R Balhorn. 2005. Computational approaches for identification of conserved/unique binding pockets in the A chain of ricin. Bioinformatics 21:3085-3096
Rost, B., Liu, J. (2005) The PredictProtein server. Nucleic Acids Res. 2003 Jul. 1; 31(13):3300-4.
Gront D., Kolinski A., HCPM—program for hierarchical clustering of protein models. Bioinformatics. July 15; 21(14):3179-80. Epub 2005 Apr. 19.
Moult, J., Fidelis, K., Zemla, A. (2003) Hubbard T., Critical assessment of methods of protein structure prediction (CASP)-round V., Proteins; 53 Suppl 6:334-9.
Prager, E. M., Wilson, A. C. (1978) Construction of phylogenetic trees for proteins and nucleic acids: empirical evaluation of alternative matrix methods. J Mol. Evol. June 20; 11(2): 129-42.
Bonneau, R., Tsai, J., Ruczinski, I. and Baker, D. (2001) Functional inferences from blind ab initio protein structure predictions. J. Struct. Biol., 134, 186-190.
Kuhlman, B., Dantas, G., Ireton, G. C., Varani, G., Stoddard, B. L. and Baker, D. (2003) Design of a novel globular protein fold with atomic-level accuracy. Science, 302, 1364-1368. 61.
Dantas, G., Kuhlman, B., Callender, D., Wong, M. and Baker, (2003) A large scale test of computational protein design: folding and stability of nine completely redesigned globular proteins. J. Mol. Biol., 332, 449-460.
Attwood, T. K., Avison, H., Beck, M. E., Bewley, M., Bleasby, A. J., Brewster, F., Cooper, P., Degtyarendko, K., Geddes, A. J., Flower, D. R., Kelly, M. P., Lott, S., Measures, K. M., Parry-Smith, D. J., Perkins, D. N., Scordis, P., Scott, D., and Worledge, C. (1997) The PRINTS database of protein fingerprints: A novel information resource for computational molecular biology. J Chem Inf Comput Sci, 37, 417-424.
Berman, H. M., Westbrook, J., Feng, Z., Gilliland, G., Bhat, T. N., Weissig, H., Shindyalov, I. N., and Bourne, P. E. (2000) The protein data bank. Nucleic Acids Research, 8, 235-242.
Bower, M. J., Cohen, F. E. and Dunbrack, R. L. (1997) Prediction of protein side-chain rotamers from a backbone-dependent rotamer library: a new homology modeling tool. J Mol Biol, 267, 1268-1282.
Canutescu A. A., Shelenkov A. A. and Dunbrack, R. L. (2003) A graph theory algorithm for protein side-chain prediction. Prot Sci, 12, 2001-2014.
Day, P. J., Emst, S. R., Frankel, A. E., Monzingo, A. F., Pascal, J. M., Molina-Svinth, M. C. and Robertus, J. D. (1996) Structure and activity of an active site substitution of ricin A chain. Biochemistry, 35, 11098-11103.
Ewing, T. J. A., S. Makino, A. G. Skillman, I. D. Kuntz. 2001. DOCK 4.0: Search strategies for automated molecular docking of flexible molecule databases. Journal of Computer-Aided Molecular Design 15: 411-428.
Fygenson, D. K., Needlemen, D. J. and Sneppen, K. (2004) Variability-based sequence alignment identifies residues responsible for functional differences in a and b tubulin. Protein Science, 13, 25-31.
Gabdoulkhakov, A. G., Savochkina, Y., Konareva, N., Krauspenhaar, R., Stoeva, S., Nikonov, S. V., Voelter, W., Betzel, C., Mickhailov, A. M. Structure-Function Investigation Comlex of Agglutinin from Ricinus Communis with Galactoaza (to be published).
Gardner, S., Lam, M. W., Mulakken, N. J., Torres, C. L., Smith, J. R. and Slezak, T. R. (2004) Sequencing needs for viral diagnostics. Journal of Clinical Microbiology, 42, 0095-1137.
Hubbard, S. J. and Thornton, J. M. (1993) ‘NACCESS’, Computer Program, Department of Biochemistry and Molecular Biology, University College, London.
Karlin, S. and Ghandour, G. (1985) Multiple-alphabet amino acid sequence comparison of the immunoglobulin k-chain constant domain. Proc. Natl. Acad. Sci. USA, 82, 8597-8601.
Knight, B. (1979) Ricin—a potent homicidal poison. British Medical Journal, 278, 350-351.
Kuntz, I. D., Blaney, J. M., Oatley, S. J., Langridge, R. and Ferrin, T. E. (1982) A geometric approach to macromolecule-ligand interactions. J. Mol. Biol., 161, 269-288.
Lebeda, F. J. and Olson, M. A. (1999) Prediction of a conserved, neutralizing epitope in ribosome-inactivating proteins. International Journal of Biological Macromolecules, 24, 19-26.
Lightstone, F. C., Prieto, M. C., Singh, A. K., Piqueras, M. C., Whittal, R. M., Knapp, M. S., Balhorn, R. and Roe, D. C. (2000) Identification of novel small molecule ligands that bind to tetanus toxin. Chem Res Toxicol., 13, 356-362.
Lord, J. M., Roberts, L. M. and Robertus, J. D. (1994) Ricin: structure, mode of action, and some current applications. FASEB J, 8, 201-208.
Marsden, C. J., Fulop, V., Day, P. J and Lord, J. M. (2004) The effects of mutations surrounding and within the active site on the catalytic activity of ricin A chain. Eur. J. Biochem., 271, 153-162.
   12
Olson, M. A., Carra, J. H., Roxas-Duncan, V., Wannemacher, R. W., Smith, L. A., and Millard, C. B. (2004) Finding a new vaccine in the ricin protein fold. Protein Engineering, Design & Selection, 17, 391-397.
Olsnes, S. and Kozlov, J. V. (2001) Ricin. Toxicon 39:1723-1728.
Ouzounis, C. A., Coulson, R. M., Enright, A. J., Kunin, V., Pereira-Leal, J. B. (2003) Classification schemes for protein structure and function. Nat Rev Genet., 4, 508-519.
Peruski, A. H., and Peruski, Jr, L. F. (2003) Immunological methods for detection and identification of infectious disease and biological warfare agents. Clinical and Diagnostic Laboratory Immunology, 10, 506-513.
Portefaix, J.-M., S. Thebault, F. Bourgain-Guglielmetti, M. D. Del Rio, C. Granier, J.-C. Mani, I. Navarro-Teulon, M. Nicolas, T. Soussi, and B. Pau. 2000. Critical residues of epitopes recognized by several anti-p53 monoclonal antibodies correspond to key residues of p53 involved in interactions with the mdm2 protein. Journal of Immunological methods 244: 17-28.
Sayle, R. A. and Milner-White, E. J. 1995. RasMol: Biomolecular graphics for all. Trends in Biochemical Sciences, 20, 374-376.
Shuker, S. B., Hajduk, P. J., Meadows, R. P. and Fesik, S. W. (1996) Discovering High-Affinity Ligands for Proteins: SAR by NMR. Science, 274, 1531-1534.
Slezak, T., Kuczmarski, T., Ott, L., Torres, C., Medeiros, D., Smith, J., Truitt, B., Mulakken, N., Lam, M., Vitalis, E., Zemla, A., Zhou, C. E. and Gardner, S. (2003) Comparative genomics tools applied to bioterrorism defense. Briefings in Bioinformatics, 4, 133-149.
Wang, G., De, J., Schoeniger, J. S., Roe, D. C. and Carbonell, R. G. (2004) A hexamer peptide ligand that binds selectively to staphylococcal enterotoxin B: isolation from a solid phase combinatorial library. Journal of Peptide Research, 64, 51-64.
Wesche, J., Rapak, A. and Olsnes, S. (1999) Dependence of ricin toxicity on translocation of the toxin A-chain from the endoplasmic reticulum to the cytosol. J Biol Chem, 274, 34443-34449.
Weston, S. A., Tucker, A. D., Thatcher, D. R., Derbyshire, D. J. and Pauptit, R. A. (1994) X-ray structure of recombinant ricin A-chain at 1.8 Å resolution. J. Mol. Biol., 244, 410-422.
Yan, X., Hollis, T., Svinth, M., Day, P., Monzingo, A. F., Milne, G. W., Robertus, J. D. (1997) Structure-based identification of a ricin inhibitor. J Mol Biol, 266, 1043.
Zemla, A. (2003) LGA: a method for finding 3D similarities in protein structures. Nucleic Acid Research, 31, 3370-3374.
Zemla, A., Ecale Zhou, C., Slezak, T., Kuczmarski, T., Rama, D., Torres, C, Sawicka, D. and Barsky, D. (2005) AS2TS system for protein structure modeling and analysis. Nucleic Acids Research, 1; 33(Web Server issue):W111-5.

What is claimed is:

1. A computer implemented method of scoring residue frequency in a local sequence context for a residue in a polypeptide sequence, comprising:
generating a first set of subsequences comprising a first residue, wherein each subsequence within said first set comprises a plurality of contiguous residues and said first residue;
generating a first set of occurrence frequencies, wherein each occurrence frequency within said first set is based on the occurrence of a subsequence of said first set of subsequences within a dataset of sequence;
generating a first score based on the first set of occurrence frequencies; and
storing said first score.

2. The method of claim 1, wherein said dataset comprises a plurality of protein sequences.

3. The method of claim 1, wherein generating said set of occurrence frequencies further comprises:
generating a second set of subsequences from said dataset of sequence, wherein each subsequence within said second set comprises a plurality of contiguous residues;
generating a second set of occurrence frequencies, wherein each occurrence frequency within said second set is based on the occurrence of a subsequence of said second set of subsequences within said dataset of sequence;
generating a set of records, each record comprising a subsequence of said second set of subsequences and an associated occurrence frequency;
identifying for a subsequence of said first set of subsequences a second occurrence frequency responsive to searching said set of records for said subsequence of said first set of records; and
storing said second occurrence frequency.

4. The method of claim 3, wherein searching said set of records for said subsequence further comprises identifying a record comprising a residue substitution, said substitution defined by a set of allowed residue substitutions.

5. The method of claim 1, wherein generating said first set of occurrence frequencies further comprises generating an alignment between a subsequence included within said first set of subsequences and a dataset of sequence, said alignment comprising a correspondence between one or more residues in said subsequence included within said first set of subsequences and one or more residues in the dataset of sequence.

6. The method of claim 1, further comprising generating a plurality of scores for a plurality of residues in said polypeptide sequence according to the method steps of claim 1.

7. The method of claim 6, further comprising combining said plurality of scores to generate a score for said polypeptide.

8. The method of claim 6, further comprising combining said plurality of scores with a plurality of scores indicative of the probability that a residue is a surface residue.

9. The method of claim 6, further comprising combining said scores with a score indicative of the conservation of a residue within a group of homologs, the uniqueness of a residue relative to a set of known confounders or a combination thereof.

10. The method of claim 6, further comprising identifying a signature comprising a subsequence of said polypeptide based on the plurality of scores, wherein said plurality each has a score that exceeds a threshold value.

11. The method of claim 6, further comprising displaying said scores onto a representation of a three-dimensional structure of said polypeptide.

12. The method of claim 1, wherein a starting residue number of each subsequence within said first set of subsequences differs by one position in said polypeptide sequence.

13. The method of claim 1, further comprising normalizing said first score.

14. The method of claim 13, wherein said normalizing is based on said dataset of sequence.

15. The method of claim 6, further comprising normalizing said first score, wherein said normalizing is based on said plurality of scores.

16. The method of claim 1, wherein said plurality consists of four residues.

17. The method of claim 1, wherein said plurality consists of five residues.

18. The method of claim 1, wherein said plurality consists of six residues.

19. A computer readable storage medium containing computer program code for scoring residue frequency in a local sequence context for a residue in a polypeptide sequence, the program code comprising:
generating a first set of subsequences comprising a first residue, wherein each subsequence within said first set comprises a plurality of contiguous residues and said first residue;
generating a first set of occurrence frequencies, wherein each occurrence frequency within said first set is based on the occurrence of a subsequence of said first set of subsequences within a dataset of sequence;
generating a first score based on the first set of occurrence frequencies; and
storing said first score.

20. The computer readable storage medium of claim 19, wherein further comprising storage code for:
generating a second set of subsequences from said dataset of sequence, wherein each subsequence within said second set comprises a plurality of contiguous residues;
generating a second set of occurrence frequencies, wherein each occurrence frequency within said second set is based on the occurrence of a subsequence of said second set of subsequences within said dataset of sequence;
generating a set of records, each record comprising a subsequence of said second set of subsequences and an associated occurrence frequency; and
identifying for a subsequence of said first set of subsequences a second occurrence frequency responsive to searching said set of records for said subsequence of said first set of records; and
storing said second occurrence frequency.
